(19) United States
(12) Patent Application Publication
(10) Pub. No.: US 2006/0281478 A1
(43) Pub. Date: Dec. 14, 2006

(54) Method, apparatus and computer program product to optimize information provision in MBMS neighboring cell information (MNCI) message

(75) Inventor: Antti O. Kangas, Oulunsalo (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/451,744

(22) Filed: Jun. 12, 2006

Related U.S. Application Data
(60) Provisional application No. 60/690,186, filed on Jun. 13, 2005.

(51) Int. Cl. H04Q 7/20

(52) U.S. Cl. 455/509; 455/525

(57) ABSTRACT

A method includes distributing an information related to a neighboring cell over a plurality of message instances each comprising a change mark value referring to the information, and transmitting the plurality of message instances.

### CROSS REFERENCE TO RELATED APPLICATION

This Application claims the benefit under 35 USC 119(e) of U.S. Provisional Application No. 60/690,186 filed Jun. 13, 2005.

### TECHNICAL FIELD:

The exemplary and non-limiting embodiments of this invention relate generally to wireless digital communication systems and, more specifically, relate to GSM/EDGE cellular communication systems.

### BACKGROUND

The following abbreviations appear in this patent application, and are defined as follows:
ARFCN Absolute Radio Frequency Channel Number
BSIC Base Station Identity Code
BSS Base Station System
EDGE Enhanced Data rates for Global Evolution
EGPRS GPRS operating over EDGE
GERAN GSM/EDGE Radio Access Network
GSM Global System for Mobile Communications
GPRS General Packet radio Service
HSN Hopping Sequence Number
MAC Medium Access Control
MBMS Multimedia Broadcast/Multicast Service
MNCI MBMS Neighboring Cell Information
MAIO Mobile Allocation Index Offset
PBCCH Packet Broadcast Control Channel
PCU Packet Control Unit
RLC Radio Link Control
TSC Training Sequence Code

The MNCI message (as described in early versions of standards document 3GPP TS 44.060) is a RLC/MAC control message. As specified, the message is not to be segmented. However, the information content can be divided between several instances of the MNCI message. The length of a non-segmented RLC/MAC control message is 23 octets (or 23*8 bits=184 bits).

The information that needs to be carried in the MNCI message includes the following:
A) Identification of the neighboring cell, by means of referring to the neighbor list in the serving cell, and optionally also a BSIC of the neighboring cell, if such is not provided in the serving cell.
B) Frequency parameters that include an information element describing a channel, by means of a TSC and, in case no frequency hopping is applied, a single ARFCN, or in then case where frequency hopping is applied, a list of ARFCNs describing the set of radio channels which shall be applied in the frequency hopping sequence; a MAIO describing the index from which the hopping sequence is started, and a HSN determining a further hopping sequence generation parameter. In the case where frequency hopping is applied, the parameters are provided in a specified way (direct 2 encoding format as per 3GPP TS 44.060).
C) MBMS point-to-multipoint (p-t-m) bearer parameters for one or more MBMS p-t-m bearers sharing the same frequency parameters.
D) The description of the PBCCH channel, if the neighboring cell has one allocated.

Due to the coding of the MNCI message, if the MNCI message is to give the parameters for a MBMS p-t-m bearer, then the frequency parameters are defined to be included in the same MNCI message instance.

However, in the case or instance where frequency hopping is applied, the foregoing requirement cannot be met in all cases, depending on the amount of radio channels used in the hopping sequence, i.e., on the length of the required frequency list information element required to describe the set of radio channels used in the hopping sequence.

Even were it to be possible to fit the information for one MBMS p-t-m bearer (when frequency hopping is used) in one message, it would become difficult or even impossible to present several MBMS p-t-m bearers in the neighbor cell sharing the same frequency parameters in a single message, as was the intention when the message encoding was originally specified. Therefore, in this situation a new instance of the message would be required, in which the same frequency parameters would need to be encoded again, and may likely force yet another instance of the message to be created for the remainder of the information.

In short, previously specified techniques for encoding the MNCI message are problematic. Specifically, in certain cases it is impossible to convey the information it was created to convey, and in cases where several MBMS p-t-m bearers are established in the neighboring cell, there likely arises the need to create additional MNCI message instances in which the same frequency parameters are repeatedly encoded, and thus may require creating yet new instances of the MNCI message. Further, all instances of an MNCI message consume capacity for MBMS data, as well as increase the probability that a mobile station does not have a complete set of information for the neighboring cells (i.e., all the MNCI messages directed towards such cells). In addition, in the typical case where there are several neighboring cells, for all of which the MNCI message may need to be transmitted by the network in the MBMS p-t-m bearer, the trunking loss introduced by the presence of multiple unnecessary instances of the MNCI messages is multiplied by the number of neighboring cells for which MNCI messages are sent.

### SUMMARY

The foregoing and other problems are overcome, and other advantages are realized, in accordance with the exemplary embodiments of these teachings.

In accordance with an exemplary embodiment of the invention, a method includes distributing an information related to a neighboring cell over a plurality of message instances each comprising a change mark value referring to the information, and transmitting the plurality of message instances.

In accordance with another exemplary embodiment of the invention, a method includes receiving a plurality of message instances each comprising a change mark value referring to an information related to a neighboring cell distributed over the plurality of message instances, and using the change mark value to combine the information.

In accordance with another exemplary embodiment of the invention, a mobile terminal includes a transceiver, a processor coupled to the transceiver, and a memory coupled to the processor for storing a set of instructions, executable by the processor, receiving a plurality of message instances each comprising a change mark value referring to an information related to a neighboring cell distributed over the plurality of message instances, and using the change mark value to combine the information.

In accordance with another exemplary embodiment of the invention, a program of machine-readable instructions, tangibly embodied on an information bearing medium and executable by a digital data processor, perform actions including distributing an information related to a neighboring cell over a plurality of message instances each comprising a change mark value referring to the information, and transmitting the plurality of message instances.

In accordance with another exemplary embodiment of the invention, a program of machine-readable instructions, tangibly embodied on an information bearing medium and executable by a digital data processor, to perform actions includes receiving a plurality of message instances each comprising a change mark value referring to an information related to a neighboring cell distributed over the plurality of message instances, and using the change mark value to combine the information.

In accordance with another exemplary embodiment of the invention, a network element includes a wireless transceiver, a processor coupled to the wireless transceiver, and a memory coupled to the processor for storing a set of instructions, executable by the processor, for distributing an information over a plurality of MBMS neighboring Cell Information (MNCI) message instances if not all of the information fits into one of the plurality of MNCI message instances wherein each of the plurality of MNCI message instances comprises a change mark value referring to the information, and transmitting the plurality of MNCI message instances.

In accordance with another exemplary embodiment of the invention, a method includes distributing an information over a plurality of Multimedia Broadcast/Multicast Service (MBMS) Neighboring Cell Information (MNCI) messages if not all of the information fits into one MNCI message, wherein each of the plurality of MNCI messages include a change mark value for the information, a MBMS p-t-m Frequency Parameters structure including a frequency list number, a Training Sequence Code (TSC), an Absolute Radio Frequency Channel Number (ARFCN), a Mobile Allocation Index Offset (MAIO), and a Hopping Sequence Number (HSN), and a MBMS Frequency structure list including the frequency list number, a Length of Frequency List contents field, and a Frequency List contents field.

In accordance with another exemplary embodiment of the invention, a method includes receiving a plurality Multimedia Broadcast/Multicast Service (MBMS) Neighboring Cell Information (MNCI) messages, over which is distributed an information, each including a change mark value for the information, a MBMS p-t-m Frequency Parameters structure including a frequency list number, a Training Sequence Code (TSC), an Absolute Radio Frequency Channel Number (ARFCN), a Mobile Allocation Index Offset (MAIO), and a Hopping Sequence Number (HSN), and a MBMS Frequency structure list including the frequency list number, a Length of Frequency List contents field, and a Frequency List contents field, and using the change mark value to combine the information from the plurality of MNCI messages.

### BRIEF DESCRIPTION OF THE DRAWINGS

The foregoing and other aspects of the exemplary embodiments of this invention are made more evident in the following Detailed Description, when read in conjunction with the attached Drawing Figure, wherein:

FIG. 1 is a simplified block diagram of a wireless communications network for practicing exemplary embodiments of the invention.

FIG. 2 is a depiction of a data structure/message format for conveying information known in the art.

FIG. 3 is a depiction of a data structure/message format for conveying neighboring cell information according to exemplary embodiments of the invention.

FIG. 4 is a flow chart of a method according to exemplary embodiments of the invention.

FIG. 5 is a flow chart of a method according to another exemplary embodiments of the invention.

### DETAILED DESCRIPTION

Exemplary and non-limiting embodiments of the invention disclose a computer program, as well as a method and apparatus, for arranging the information in an MNCI message as well the manner in which the information is encoded. The exemplary embodiments of an MNCI message according to the invention enable information and data conveyed in separate MNCI message instances to be cross referenced between the instances, thereby providing a cross-message reference mechanism. Alternative exemplary embodiments of the invention disclose breaking down or partitioning certain data elements into smaller pieces to enable the the use of the cross-message reference mechanism. As a result, the utilization of these aspects of exemplary embodiments of the invention allows for the introduction/encoding of the hopping frequency parameters without length constraints in one MNCI message instance as described more fully below.

3GPP TS 44.018 (Annex J.3) describes how many octets are needed to present a frequency of n channels in GSM frequency band m. A calculation of the space required to present one MBMS p-t-m channel in the MNCI message can be made assuming the following: BSIC needs to be used to identify the neighboring cell; frequency hopping is used; the MBMS bearer uses EGPRS; uplink (mobile station to network) feedback is used; and the MBMS radio bearer starting time is used.

In the case that these assumptions are met, the maximum length of the frequency list information element that can be accommodated in the MNCI message is 10 octets. In practice, there is often times included the information element identifier (IEI) of the Frequency List IE and, as a result, the maximum length is reduced to nine octets. However, omission of the IEI of the Frequency List IE in accordance with 3GPP TS 44.018 (Annex J.3) permits the inclusion of ten octets of frequency list information.

With a frequency list of this length, the number of channels that can be represented is relatively low, and as a result, this low number of channels can prove insufficient in many deployed network configurations. As noted above, exemplary embodiments of the invention allow for the introduction/encoding of the hopping frequency parameters without length constraints in one MNCI message instance as described more fully below.

Other exemplary embodiments of the invention allow for the introduction of the MBMS p-t-m bearers in other instances of the MNCI message (if necessary), and in the MBMS p-t-m bearer description reference it is possible to refer to the frequency parameters introduced in another instance of the MNCI message.

The use of these exemplary embodiments of the invention further solves the problem of not being able to give a MBMS p-t-m description in some cases, thereby achieving enhanced trunking gain by making it possible to minimize usage (and thus the amount of required instances) of the MNCI message(s).

In practice, a re-arrangement of the MNCI message is not always sufficient to provide all of the benefits discussed above. Therefore, exemplary embodiments of the invention include a change mark field in each MNCI message in order to reliably refer to information between message instances, thus ensuring that the message “pieces” match one another. This attribute of exemplary embodiments of the MNCI message of the invention is provided, in part, in recognition that the MBMS parameters are dynamic in nature and can change “on the fly”. It is further noted that the change mark field is used for other purposes as well.

Also, in order to make it possible to use more than one set of frequency parameters (as was originally envisioned in the MNCI message coding), it is preferred that an identifier be assigned to each frequency parameter construction, to which an unambiguous link can be made when referring to such parameters.

Further, exemplary embodiments of the invention introduce additional data structures for use in the instance that several different (by means of MAIO) hopping frequency parameters can be conveyed and accessed such that the largest part of the information (the Frequency List) is shared between the frequency parameters (as it is typically the case), whereas the MAIO (and perhaps the HSN) can be given separately, thus saving several octets (approximately ten octets in some cases) of space.

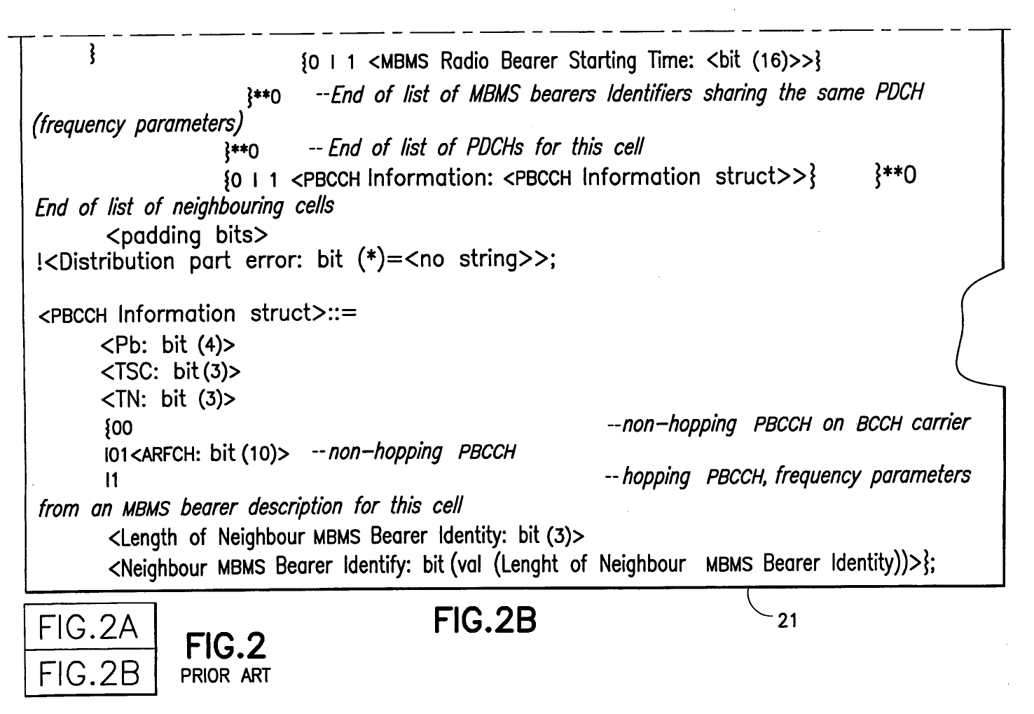

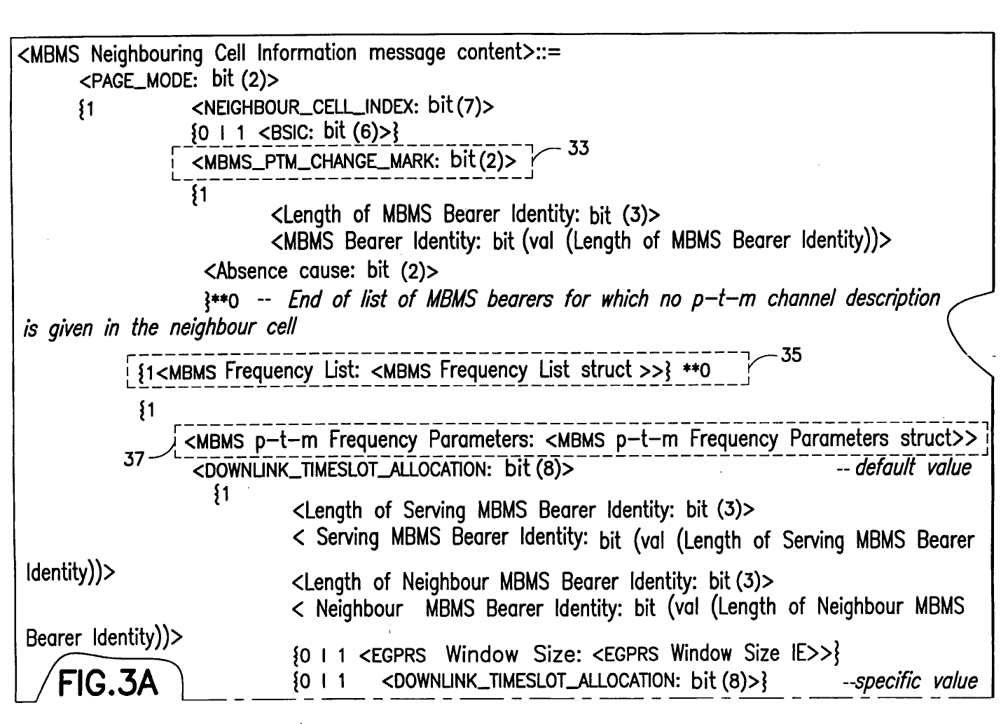

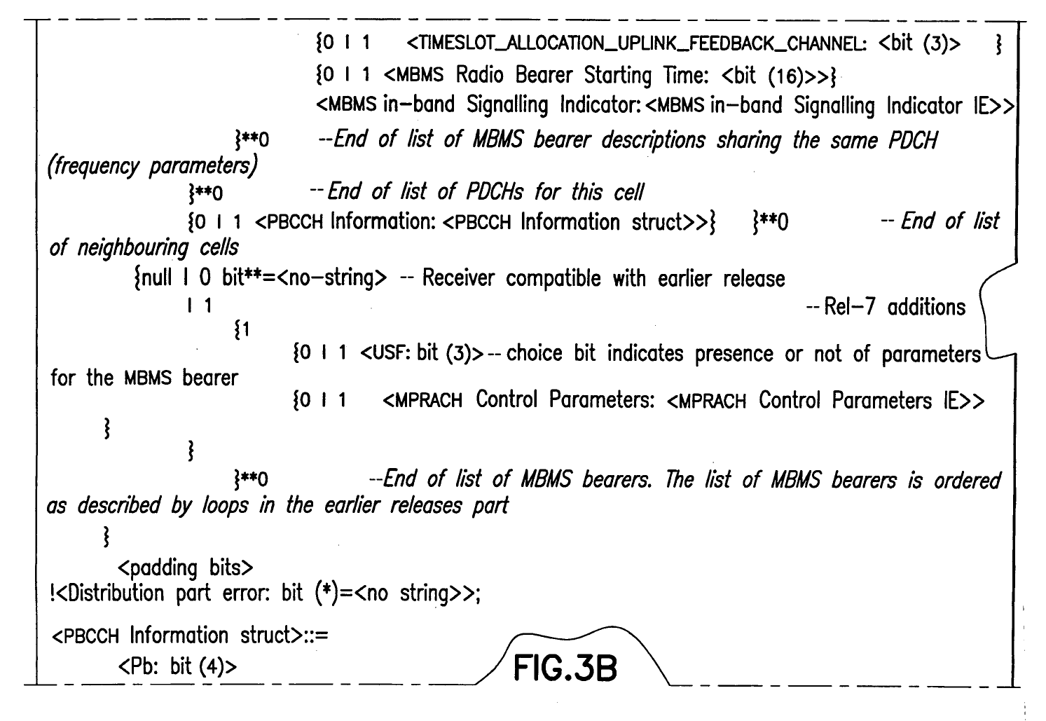

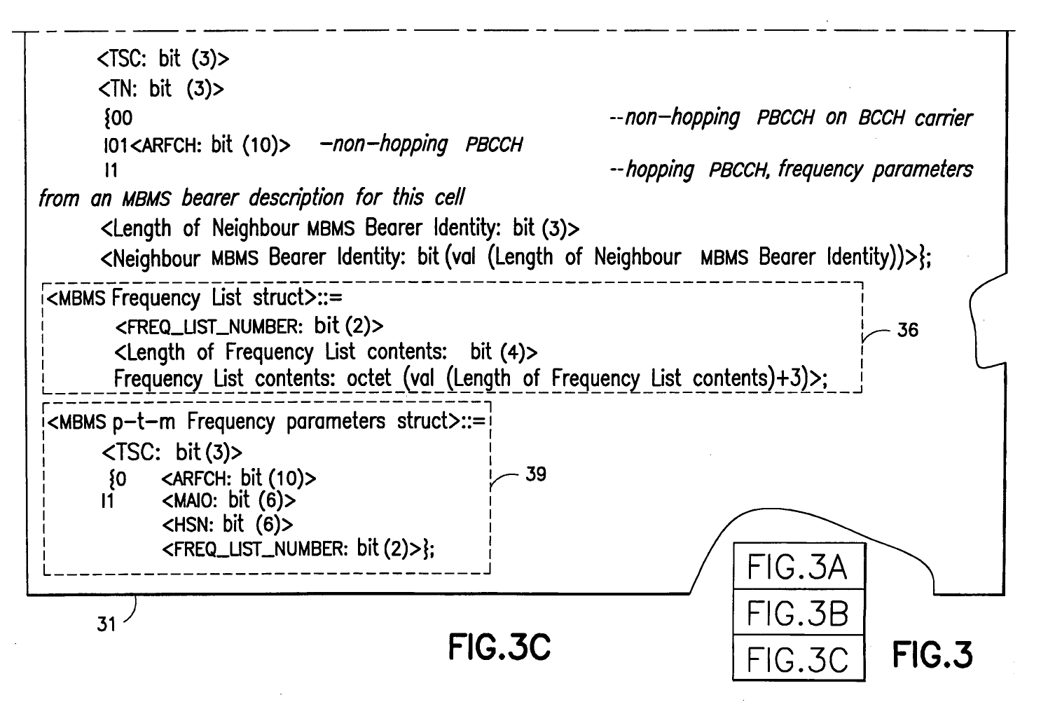

An exemplary embodiment of the invention is illustrated with reference to FIGS. 2 and 3. FIG. 2 illustrates a conventional MNCI encoding as embodied in MBMS NEIGHBOURING CELL INFORMATION message 21. With reference to FIG. 3, there is illustrated an exemplary and non-limiting embodiment of an MBMS NEIGHBOURING CELL INFORMATION (MNCI) message, in particularly a MNCI message 31, according to the invention. MNCI message 31 is an optional message sent by a network on the PACCH to provide details of the bearer allocated to a particular MBMS session in a neighbouring cell. MNCI message 31 is not segmented across more than one RLC/MAC control block. If not all of the information fits into one instance of the MNCI message 31, the information can be distributed over more than one instance of the MNCI message 31.

In the exemplary embodiment illustrated, a change mark field 33 is included in the MNCI message 31: (<MBMS_PTM_CHANGE_MARK: bit (2)>). Change mark field 33 contains the change mark value for the information given for a specific neighboring cell. This information is used to combine information from multiple instances of the MNCI message 31. Frequency list field 35 (<MBMS Frequency List: <MBMS Frequency List struct>) specifies the separate repeat structure used to provide one or more Frequency Lists, each identified via a FREQ_LIST_NUMBER field. The format of a MBMS Frequency List structure, forming part of the frequency list field 35, is defined at frequency list structure definition 36.

The information pertaining to the break-down/replacement of the Frequency Parameters information element of MNCI message 21 is contained in MBMS p-t-m Frequency Parameters field 37: (<MBMS p-t-m Frequency Parameters: <MBMS p-t-m Frequency Parameters struct >>)**0). As shown in MBMS p-t-m Frequency Parameters structure definition 39, there is defined a TSC and a single-bit choice (as one bit is sufficient to present two choices) for non-hopping/hopping, where non-hopping implies ARFCN and hopping implies MAIO, HSN and a reference to a frequency list (via the FREQ_LIST_NUMBER field).

In other exemplary and non-limiting embodiments of the invention, different combinations of the fields 33, 35, 37 can be included in the MNCI message 31 as shown above. For example, it may be that the break-down of the MBMS p-t-m Frequency Parameters field 37 is not required. In such an instance, reference is made to a Frequency Parameters field 23, not to a broken-down (partitioned) part of the structure (Frequency List field 35).

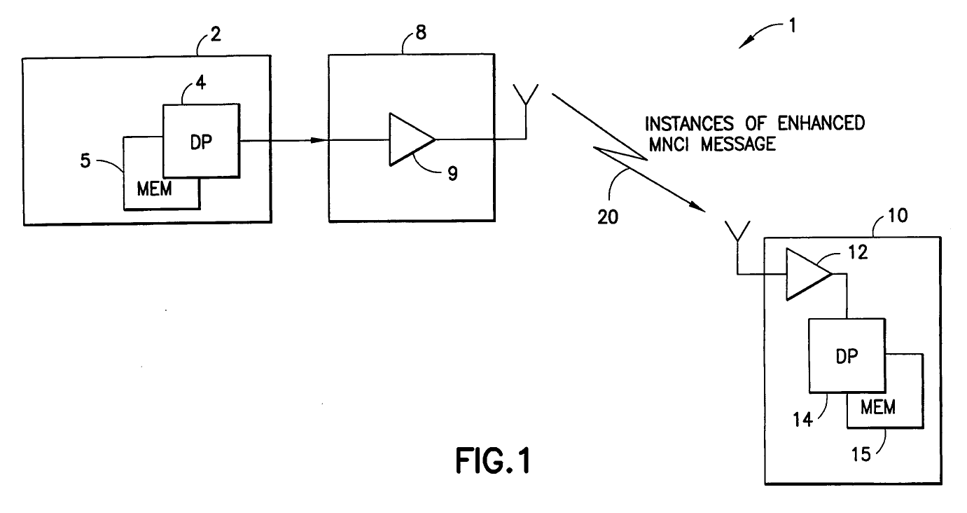

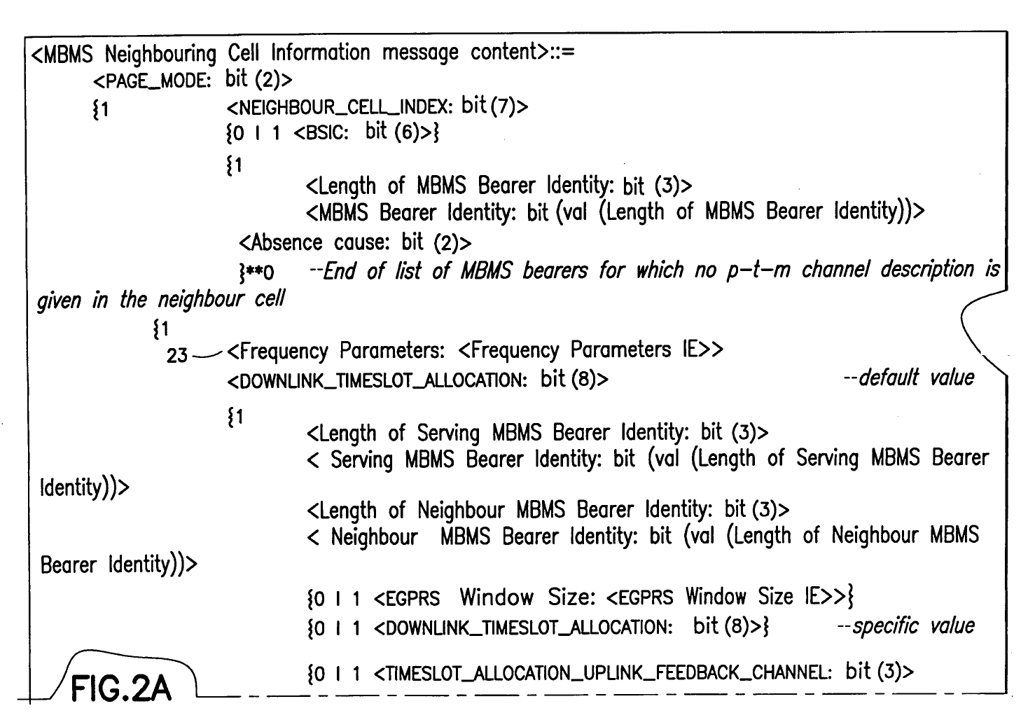

FIG. 1 shows a block diagram of a wireless communications network 1 having a network element 2 coupled to a base station 8 having a transmitter 9 for transmitting information, including the exemplary embodiments of the MNCI message 31 as described above, to a mobile station 10 over a wireless link 20. The network element 2 is assumed to include a suitably programmed data processor 4, where the program resides on or in a data storage medium 5 that is readable by the data processor 4, that operates to compose the MNCI message 31 as discussed above. The network element 2 may form a part of the BSS, and more specifically may comprise the PCU, although the functionality of the network element 2 is not limited to residing in the PCU or the BSS. The mobile station 10 is assumed to include a receiver 12 and a suitably programmed data processor 14, where the program resides on or in a data storage medium 15 that is readable by the data processor 14, that operates to correctly respond to multiple instances of the MNCI message 31 that are received from the base station transmitter 9.

In general, the various exemplary embodiments of the mobile station 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The use of the exemplary embodiments of this invention solves the problem of an inability to provide a MBMS p-t-m description in certain network cases, e.g., not being able to provide hopping frequency parameters in certain frequency bands, having some certain number of hopping carriers and a certain amount of span in the ARFCN range of the carriers used in the hopping list. The use of the exemplary embodiments of this invention also facilitates the introduction of several MBMS p-t-m bearers per message.

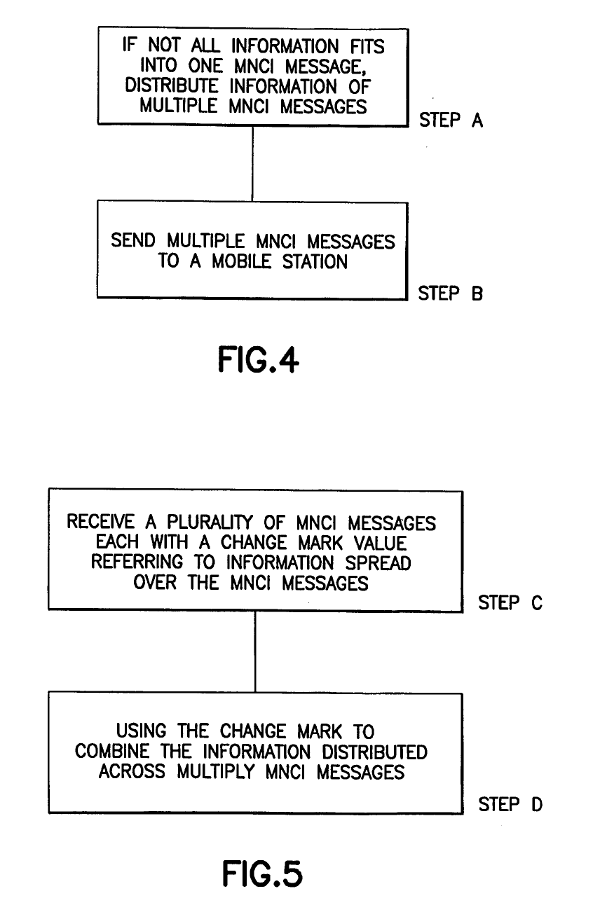

With reference to FIG. 4, there is illustrated an exemplary embodiment of a method of the invention. At step A, in the instance that not all of the information to be transmitted in an MNCI message fits into one MNCI message, the information is distributed across multiple MNCI messages. At step B, the multiple MNCI messages are sent to a mobile station.

In accordance with an apparatus, method and computer program product in accordance with non-limiting embodiments of this invention there is provided a technique for execution by a network element where, if not all information fits into one instance of the MNCI message 31, the information is distributed over more than one instance of the MNCI message 31 that are sent or otherwise transmitted to a mobile station.

With reference to FIG. 5. there is illustrated another exemplary embodiment of a method of the invention. At step C, a mobile station receives a plurality of MNCI messages each having a change mark value referring to the information spread over the multiple MNCI messages. The mobile station uses the change mark value to combine the information distributed across the multiple MNCI messages. At step D, the change mark value is used to combine the information distributed across multiple MNCI messages.

Further in accordance with an apparatus, method and computer program product in accordance with non-limiting embodiments of this invention there is provided a technique for a mobile station to receive and respond to a receipt of multiple instances of a MNCI message, where required information is distributed over the multiple instances of the MNCI message 31.

In the exemplary embodiments the MNCI message 31 includes a change mark field 33 (MBMS_PTMCHANGE_MARK), a MBMS p-t-m Frequency Parameters structure definition 39, and a frequency list structure definition 36 (MBMS Frequency List structure). The MBMS p-t-m Frequency Parameters structure definition 39 can include information elements, interpreted as a function of the state of the change mark field 33, as follows:

| < TSC : bit (3) > | |
|---|---|
| { 0 | < ARFCN : bit (10 > |
| \| 1 | < MAIO : bit (6) > |
| | < HSN : bit (6) > |
| | < FREQ_LIST_NUMBER : bit (2) > }, and |

Where, as noted above, the MBMS Frequency List structure definition 36 comprises information elements:

< FREQ_LIST_NUMBER : bit (2) >
< Length of MBMS Frequency List contents : bit (4) >
< MBMS Frequency List contents : octet (val(Length of MBMS
Frequency List contents) + 3) >.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. For example, the use of other similar or equivalent information elements, and a different ordering of the information elements in the MNCI message, may be attempted by those skilled in the art. However, all such and similar modifications of the teachings of this invention will still fall within the scope of the non-limiting embodiments of this invention.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
distributing an information related to a neighboring cell over a plurality of message instances each comprising a change mark value referring to said information; and
transmitting said plurality of message instances.

2. The method of claim 1 wherein each of said plurality of message instances comprise a MBMS Neighboring Cell Information (MNCI) message.

3. The method of claim 1 wherein each of said plurality of message instances comprise at least one frequency list.

4. The method of claim 3 wherein said at least one frequency list comprises a frequency list structure.

5. The method of claim 4 wherein said frequency list structure comprises at least one of a frequency list number field, a length of frequency list contents field, and a frequency list contents field.

6. The method of claim 1 wherein each of said plurality of message instances comprise at least one frequency parameter structure.

7. The method of claim 6 wherein said at least one frequency parameter structure comprises at least one of an Absolute Radio Frequency Channel Number (ARFCN) field, a Mobile Allocation Index Offset (MAIO) field, a Hopping Sequence Number (HSN) field, and a frequency list number field.

8. A method comprising:
receiving a plurality of message instances each comprising a change mark value referring to an information related to a neighboring cell distributed over said plurality of message instances; and
using said change mark value to combine said information.

9. The method of claim 8 wherein each of said plurality of message instances comprise a MBMS Neighboring Cell Information (MNCI) message.

10. The method of claim 8 wherein each of said plurality of message instances comprise at least one frequency list.

11. The method of claim 10 wherein said at least one frequency list comprises a frequency list structure.

12. The method of claim 11 wherein said frequency list structure comprises at least one of a frequency list number field, a length of frequency list contents field, and a frequency list contents field.

13. The method of claim 8 wherein each of said plurality of message instances comprise at least one frequency parameter structure.

14. The method of claim 13 wherein said at least one frequency parameter structure comprises at least one of an Absolute Radio Frequency Channel Number (ARFCN) field, a Mobile Allocation Index Offset (MAIO) field, a Hopping Sequence Number (HSN) field, and a frequency list number field.

15. A mobile terminal comprising:
a transceiver;
a processor coupled to the transceiver; and
a memory coupled to the processor for storing a set of instructions, executable by the processor, receiving a plurality of message instances each comprising a change mark value referring to an information related to a neighboring cell distributed over the plurality of message instances, and using the change mark value to combine the information.

16. The mobile terminal of claim 15 wherein each of said plurality of message instances comprise a MBMS Neighboring Cell Information (MNCI) message.

17. The mobile terminal of claim 15 wherein each of said plurality of message instances comprise at least one frequency list.

18. The mobile terminal of claim 17 wherein said at least one frequency list comprises a frequency list structure.

19. The mobile terminal of claim 18 wherein said frequency list structure comprises at least one of a frequency list number field, a length of frequency list contents field, and a frequency list contents field.

20. The mobile terminal of claim 15 wherein each of said plurality of message instances comprise at least one frequency parameter structure.

21. The mobile terminal of claim 20 wherein said at least one frequency parameter structure comprises at least one of an Absolute Radio Frequency Channel Number (ARFCN) field, a Mobile Allocation Index Offset (MAIO) field, a Hopping Sequence Number (HSN) field, and a frequency list number field.

22. A program of machine-readable instructions, tangibly embodied on an information bearing medium and executable by a digital data processor, to perform actions comprising:
distributing an information related to a neighboring cell over a plurality of message instances each comprising a change mark value referring to said information; and
transmitting said plurality of message instances.

23. The program of claim 22 wherein each of said plurality of message instances comprise a MBMS Neighboring Cell Information (MNCI) message.

24. The program of claim 22 wherein each of said plurality of message instances comprise at least one frequency list.

25. The program of claim 24 wherein said at least one frequency list comprises a frequency list structure.

26. The program of claim 25 wherein said frequency list structure comprises at least one of a frequency list number field, a length of frequency list contents field, and a frequency list contents field.

27. The program of claim 22 wherein each of said plurality of message instances comprise at least one frequency parameter structure.

28. The program of claim 27 wherein said at least one frequency parameter structure comprises at least one of an Absolute Radio Frequency Channel Number (ARFCN) field, a Mobile Allocation Index Offset (MAIO) field, a Hopping Sequence Number (HSN) field, and a frequency list number field.

29. A program of machine-readable instructions, tangibly embodied on an information bearing medium and executable by a digital data processor, to perform actions comprising:
receiving a plurality of message instances each comprising a change mark value referring to an information related to a neighboring cell distributed over said plurality of message instances; and
using said change mark value to combine said information.

30. The program of claim 29 wherein each of said plurality of message instances comprise a MBMS Neighboring Cell Information (MNCI) message.

31. The program of claim 29 wherein each of said plurality of message instances comprise at least one frequency list.

32. The program of claim 31 wherein said at least one frequency list comprises a frequency list structure.

33. The program of claim 32 wherein said frequency list structure comprises at least one of a frequency list number field, a length of frequency list contents field, and a frequency list contents field.

34. The program of claim 29 wherein each of said plurality of message instances comprise at least one frequency parameter structure.

35. The program of claim 5 wherein said at least one frequency parameter structure comprises at least one of an Absolute Radio Frequency Channel Number (ARFCN) field, a Mobile Allocation Index Offset (MAIO) field, a Hopping Sequence Number (HSN) field, and a frequency list number field.

36. A network element comprising:
a wireless transceiver;
a processor coupled to the wireless transceiver; and
a memory coupled to the processor for storing a set of instructions, executable by the processor, for distributing an information over a plurality of MBMS neighboring Cell Information (MNCI) message instances if not all of said information fits into one of said plurality of MNCI message instances wherein each of said plurality of MNCI message instances comprises a change mark value referring to said information; and
transmitting said plurality of MNCI message instances.

37. A method comprising:
distributing an information over a plurality of Multimedia Broadcast/Multicast Service (MBMS) Neighboring Cell Information (MNCI) messages if not all of said information fits into one MNCI message,
wherein each of said plurality of MNCI messages comprise:
a change mark value for said information,
a MBMS p-t-m Frequency Parameters structure comprising a frequency list number, a Training Sequence Code (TSC), an Absolute Radio Frequency Channel Number (ARFCN), a Mobile Allocation Index Offset (MAIO), and a Hopping Sequence Number (HSN); and
a MBMS Frequency structure list comprising said frequency list number, a Length of Frequency List contents field, and a Frequency List contents field.

38. A method comprising:
receiving a plurality Multimedia Broadcast/Multicast Service (MBMS) Neighboring Cell Information (MNCI) messages, over which is distributed an information, each comprising:
a change mark value for said information,
a MBMS p-t-m Frequency Parameters structure comprising a frequency list number, a Training Sequence Code (TSC), an Absolute Radio Frequency Channel Number (ARFCN), a Mobile Allocation Index Offset (MAIO), and a Hopping Sequence Number (HSN); and
a MBMS Frequency structure list comprising said frequency list number, a Length of Frequency List contents field, and a Frequency List contents field; and
using said change mark value to combine said information from said plurality of MNCI messages.
